(19) United States
(12) Patent Application Publication
(10) Pub. No.: US 2010/0232535 A1
(43) Pub. Date: Sep. 16, 2010

(54) Apparatus and Method for Multilayer Space-Time-Frequency Precoding for a MIMO-OFDM Wireless Transmission System

(75) Inventors: Guosen Yue, Plainsboro, NJ (US); Li Zhang, Princeton, NJ (US); Xiaodong Wang, New York, NY (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/716,881

(22) Filed: Mar. 3, 2010

Related U.S. Application Data
(60) Provisional application No. 61/157,429, filed on Mar. 4, 2009.

(51) Int. Cl. H04L 1/02

(52) U.S. Cl. 375/267

(57) ABSTRACT

In a wireless wideband MIMO-OFDM transmission system, a method includes converting a coded bit sequence to parallel data layers, responsive to channel encoding and interleaving of an information sequence to provide the coded bit sequence; passing each data layer through a respective repetition encoder, independently interleaving respective spread data sequences from the respective repetition encoder, and amplifying the respective interleaved outputs responsive to power allocation of a respective layer of multiple layers for both I and Q channels for being combined to form complex symbols for transmission through respective multiple antennas.

This application claims the benefit of U.S. Provisional Application No. 61/157,429, entitled “Multilayer Space-Time-Frequency Coding Scheme for MIMO-OFDM”, filed on Mar. 4, 2009, the content of which is incorporated by reference herein.

### FIELD OF THE INVENTION

The present invention relates generally to wireless communications, and more particularly, multilayer space-time-frequency coding for MIMO-OFDM ((multiple-input multiple-output)-(orthogonal frequency-division multiplexing)) systems.

### BACKGROUND OF THE INVENTION

The design of linear space-time (ST) codes has been investigated for baseband MIMO systems. For wideband MIMO systems employing OFDM, the design of ST codes is then extended to the frequency domain, i.e., the space-time-frequency (STF) codes. With subcarrier grouping, the STF code design can be performed only for a small dimension along the frequency domain to maintain a manageable complexity. However, the complexity of STF code design is quite high. Moreover, the STF code design depends on the specific selections of subcarriers. The layered transmission schemes have been investigated to achieve high rate and high diversity gain for narrow band MIMO, e.g., the diagonal BLAST (D-BLAST) architecture and turbo-BLAST scheme. Recently, the interleave-division-multiplexing ST (IDM-ST) codes have been explored for narrowband multiple-input single-output (MISO) systems, where multiple forward error correction (FEC) coded sequences are independently interleaved and transmitted simultaneously from all antennas, and an iterative receiver with joint detection and decoding is employed.

In one particular prior work, L. Venturino, N. Prasad, X. Wang, and M. Madihian, “Design of linear dispersion codes for practical MIMO-OFDM systems,” IEEE J. Select. Topics Signal Processing, vol. 1, no. 1, pp. 178-188, June 2007, a linear precoding technique considers the design of linear dispersion matrix D for STF coding for particular number of transmitter and receiver antennas, and for particular number of subcarriers with a certain number of data streams. After encoding and interleaving, the binary sequence is first modulated in to QAM symbols, and then with serial-to-parallel conversion, the data symbol vector x, is multiplied by linear dispersion matrix D. The resulting symbol Dx is then transmitted through n_{T} transmit antennas and through n_{F} tones. Since the linear precode design is for particular system settings, it is not flexible for the change of systems. Also, different channel statistics result in different precoding matrix. Hence the linear precode design in that particular work may not be robust when the channel scenario changes.

In another prior work, K. Wu and L. Ping, “A quasi-random approach to space-time coding,” IEEE Trans. Inform. Theory, vol. 54, no. 3, pp. 1073-1085, March 2008, the space-time precoding employs a multilayer approach. However, that technique is only for narrow band multiple-input, single-output (MISO) system instead of wideband MIMO-OFDM to which the present invention is substantially advantageous. Also different from the present invention, in that prior work each stream is encoded by a forward error correction FEC channel encoder. Multiple channel encoders are applied. With the present invention, each stream is passed by a repetition/spreading. Moreover, with the present invention, STF precoding is performed after channel encoding; therefore, only one encoder is required. Also in the prior technique, the applied iterative MISO detection and channel decoding entails much higher complexity than that of the iterative demodulation with simple soft combiner for the present invention. The present invention is directed to a simple geometric power allocation, instead of complex vector power allocation this prior technique employs.

Accordingly, there is a need for transmission system employing a space-time-frequency STF code configuration for MIMO-OFDM using a multilayer approach with a simple geometric power allocation.

### SUMMARY OF THE INVENTION

The invention includes a multilayer space-time-frequency configuration for MIMO-OFDM systems.

In one aspect of the invention, in a wireless wideband MIMO-OFDM transmission system, a method includes converting a coded bit sequence to parallel data layers, responsive to channel encoding and interleaving of an information sequence to provide the coded bit sequence; passing each data layer through a respective repetition encoder, independently interleaving respective spread data sequences from the respective repetition encoder, and amplifying the respective interleaved outputs responsive to power allocation of a respective layer of multiple layers for both I and Q channels for being combined to form complex symbols for transmission through respective multiple antennas.

In another aspect of the invention, in a wireless wideband MIMO-OFDM transmission system, an apparatus includes converters for converting respective coded bit sequences to parallel data layers, responsive to channel encoding and interleaving of an information sequence to provide the coded bit sequence; repetition encoders responsive to the respective data layers, independent interleavers responsive to respective spread data sequences from the respective repetition encoders, and amplifiers for amplifying respective interleaved outputs responsive to power allocation of respective layers of multiple layers for both I and Q channels for being combined to form complex symbols for transmission through respective multiple antennas.

### BRIEF DESCRIPTION OF DRAWINGS

These and other advantages of the invention will be apparent to those of ordinary skill in the art by reference to the following detailed description and the accompanying drawings.

FIG. 1 is a block diagram of an exemplary MIMO-OFDM transceiver system employing multilayer space-time-frequency precoding, in accordance with the invention.

FIG. 2 is a block diagram of an exemplary transmitter configuration of multilayer space-time-frequency coding for MIMO-OFDM systems, in accordance with the invention.

FIG. 3 is a block diagram of an exemplary demodulator configuration of multilayer space-time-frequency coding for MIMO-OFDM systems, in accordance with the invention.

FIG. 4 is a block diagram of efficient linear MMSE multilayer detection with soft interference cancellation, in accordance with the invention.

### DETAILED DESCRIPTION

The invention is directed to an STF coding for MIMO-OFDM systems using a novel multilayer approach with a simple power allocation and efficient iterative demodulation with low complexity multilayer detection and a soft combiner employed at the receiver. The extrinsic scaling is applied to the extrinsic outputs during the demodulation iteration. The configuration of interleavers for multilayer STF structure is also disclosed. The resulting multilayer STF codes are flexible with the change of system settings including the number of transmitter and receiver antennas, the number of tones or subcarriers allocated. With a suboptimal LMMSE detector and simple power allocation, the performance of the inventive multilayer STF coding is close to or even better than the STF code with optimal maximum likelihood (ML) detection heretofore.

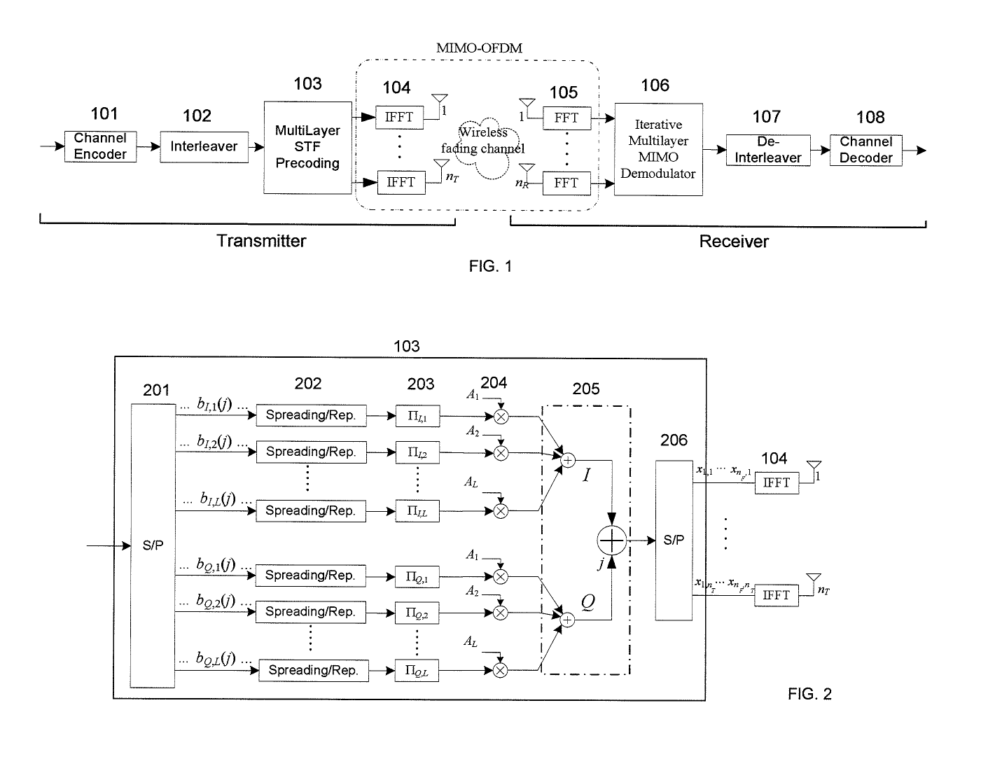

An exemplary wideband multiple-input multiple-output (MIMO) system with n_{T} transmit antennas and n_{R} receiver antennas employing orthogonal frequency-division multiplexing (OFDM) is shown in FIG. 1. At the transmitter end, the information sequence is first encoded by the channel encoder (101). After the interleaving (102), the coded bit sequence is then precoded with the multilayer space-time-frequency precoding (103). The resulting precoded symbol sequences are transmitted through multiple transmit antennas with OFDM air-interface (104), i.e., first process with inverse fast Fourier transform (IFFT) and then transmitted through n_{T} transmit antennas simultaneously. At the receiver, the wireless discrete signals are received by n_{R} receiver antennas, after FFT processes (105), the output symbols from FFT process units are then demodulated by an iterative multilayer MIMO demodulator (106). After the deinterleaver (107), the soft information output from the iterative demodulator is sent to the channel decoder (108). The channel decoder outputs are then the recovered information bits. Note that the IFFT processors (104), multiple transmitter antennas at the transmitter and the multiple-receiver antennas with FFT processors (105) form the MIMO-OFDM air-interface.

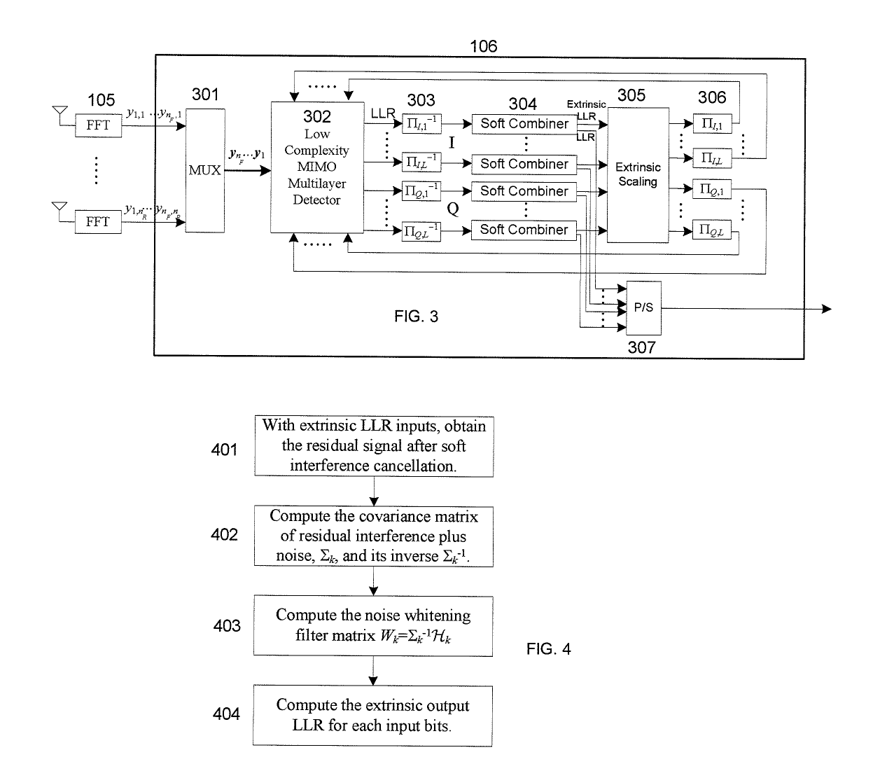

Key features of invention are the multilayer STF precoding unit 103 at the transmitter, detailed in FIG. 2, and the iterative multilayer MIMO demodulator unit 106 at the receiver, detailed in FIG. 3.

Referring now to FIG. 2 and the block diagram of an exemplary transmitter configuration of multilayer space-time-frequency coding 103, the coded bit sequence is first converted to 2L data layers by a serial-to-parallel (S/P) convertor 201. The 2L length-N_{B} binary data layers after S/P conversion, b_{l,1}, . . . , b_{I,L}, b_{Q,1}, . . . , b_{Q,L} where b_{q,l} (j)ε{ +1,−1}, q ε{I;Q}, and I and Q denote the in-phase (I) and quadrant-phase (Q) channels, respectively. Each data layer is first passed through a random spreading processor or a repetition encoder (202). The spread data sequences are then independently interleaved (203) and multiplied with amplitude factors Aₗ (204), where Aₗ=√Pₗ, and Pₗ denotes the power allocation of the lₜₕ layer for both I and Q channels. Then each group of L data layers is superimposed together to form the real (for I-channel) or imaginary part (for Q-channel) of the complex symbols (205). After serial-to-parallel (S/P) conversion (206) and the inverse fast Fourier transform (IFFT), the resulting complex symbols are transmitted through n_{T} transmit antennas over n_{F} frequency tones.

For power allocation (204), we consider the geometric power distribution across different layers with Pₗ denoting power allocation of the iₜₕ layer for both I and Q channels, according to the relationship

$${P}_{l} = \frac{{Pe}^{a ( l - 1 ) / N}}{{\sum }_{j = 1}^{L} {e}^{a ( l - 1 ) / N}} , l = 1 , … , L$$

Where P is the total power in the system, N is length of spreading repetitions (as shown by elements 202 in FIG. 2), e is the exponential constant (the Euler's number), [e^{x} denotes the exponential function]. L is the number of data layers. We then only set one parameter, α, to adjust or optimize the power levels across different layers to improve the performance. The multilayer interleavers can be designed with the elimination of short cycles.

Referring now to FIG. 3 and the block diagram of the iterative multilayer MIMO demodulator unit 106 at the receiver. After the FFT processing, the received signals from multiple receive antennas are first passed through the multiplexer MUX (301) to form the signal vector for different frequency tones and different time slots, yₗ(t), . . . , yn_{F}(t). The signal vectors are then first demodulated with a low-complexity MIMO multilayer detector (302) and the extrinsic log-likelihood-ratios (LLR) are obtained for all 2L data layers. After deinterleaving (303), the 2L layers of extrinsic LLRs are then processed by soft combiners (304) for dispreading (or repetition decoding). The 2L streams of extrinsic LLRs output from the soft combiners are first passed by the extrinsic scaling (305), i.e., multiplied by a certain scaling factor, α<1, and then interleaved and sent back to the low complexity MIMO multilayer detector as a priori inputs. After a certain number of iterations, the output combined LLRs are parallel-to-serial converted (307) and output.

For the low-complexity MIMO multilayer detector (302), two types of low-complexity suboptimal multilayer detectors with soft interference cancellation (SIC) can be applied, i.e., the linear MMSE detector and the matched filter MF detector. The SIC-MMSE detector for a particular subcarrier, e.g., the kth tone, can be efficiently implemented according to the process detailed by the block diagram of FIG. 4.

Initially, 401, given the channel matrix, Hₖ, the receive signal yₖ for the kth tone, and extrinsic input log-likelihood-ratio LLR denoted as λ^{D→M}(\tilde{s}_{k,n}), for the bit \tilde{s}_{k,n}, we first compute the soft estimate signal

$${\overline{s}}_{k , n} = tanh ( \frac{{λ}^{D \to M} ( {\tilde{s}}_{k , n} )}{2} )$$

and form the estimated vector s̅ₖ. Then we compute the residual signal, denoted as \tilde{y}ₖ−Hₖ\tilde{s}ₖ.

Then, in the next step 402, we compute the covariance matrix of residual interference plus noise, Σₖ=Hₖ^{T}VₖHₖ+σ²I, where Hₖ^{T} is the transpose of the channel matrix Hₖ, Vₖ is the residual interference, σ² is the variance of the noise and I is an identity matrix. The inverse of the covariance matrix of residual interference plus noise, Σₖ⁻¹, is also computed.

In the following step 403, we compute the linear MMSE filter matrix denoted as Wₖ=Σₖ⁻¹Hₖ, which is the product of the inverse of the covariance matrix of residual interference and channel matrix.

In the last step, 404, for every input binary bits n=1, . . . , 2n_{T}L, where n_{T} is the transmitter antenna and L is the number of layers, with a linear MMSE filter denoted as ω_{k,n}=Wₖeₙ, with Wₖ being the linear MMSE filter matrix and eₙ being a unit vector, we first obtain an intermediate computation denoted as [Ωₖ]ₙₙ=ω_{k,n}^{T}Hₖeₙ, then we compute the extrinsic LLR output from the MMSE multilayer MIMO detector given by

$${λ}^{M \to D} ( {\tilde{s}}_{k , n} ) = \frac{2}{{κ}_{k , n} - {[ {Ω}_{k} ]}_{nn}} ( {ω}_{k , n}^{T} ( {\tilde{y}}_{k} - {ℋ}_{k} {\overline{s}}_{k} ) + {[ {Ω}_{k} ]}_{nn} {\overline{s}}_{k , n} ) ,$$

where K_{k,n} is 1+ s̅_{k,n}²[Ωₖ]ₙₙ, with s̅_{k,n}² being the square of the soft signal estimate multiplied by the intermediate computation [Ωₖ]ₙₙ introduced above.

As can be seen from the above description, the inventive multilayer STF coding method for MIMO-OFDM with simple power allocation and an efficient iterative demodulator. The resulting multilayer STF codes are flexible with the change of system settings including the number of transmitter and receiver antennas, the number of tones or subcarriers allocated. Although with a suboptimal LMMSE detector and simple power allocation, the performance of the proposed multilayer STF coding is close to or even better than the STF code with optimal maximum likelihood (ML) detection in the literature.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations, which although not explicitly shown or described herein, embody the principles of the invention and are within their spirit and scope.

1. In a wireless wideband MIMO-OFDM transmission system, a method comprising the steps of:
converting a coded bit sequence to parallel data layers, responsive to channel encoding and interleaving of an information sequence to provide the coded bit sequence;
passing each data layer through a respective repetition encoder,
independently interleaving respective spread data sequences from the respective repetition encoder, and
amplifying the respective interleaved outputs responsive to power allocation of a respective layer of multiple layers for both I and Q channels for being combined to form complex symbols for transmission through respective multiple antennas.

2. The method of claim 1, wherein the amplifying comprises amplitude factors Aₗ, where Aₗ=√Pₗ, and Pₗ denotes the power allocation of the lth layer for both the I and Q channels.

3. The method of claim 2, wherein the power allocation is directly proportional to Pe^{α(l-1)/N}, where P is the total power in the system, N is a length of spreading repetitions of the spreading encoder, e is the exponential constant, l is an lₜₕ layer of the total number of data layers and α is a single parameter for adjust the power levels across different layers to change performance the wideband MIMO-OFDM transmission system.

4. The method of claim 2, wherein the power allocation is indirectly proportional to e^{α(l-1)/N}, where N is a length of spreading repetitions of the spreading encoder, e is a geometric constant, l is an lₜₕ layer of the total number of data layers and α is a single parameter for adjust the power levels across different layers to change performance the wideband MIMO-OFDM transmission system.

5. The method of claim 1, further comprising the step of detecting information from reception of the transmitted complex symbols for obtaining respective log-likelihood ratios LLRs for all the data layers.

6. The method of claim 5, wherein the detecting comprises soft interference cancellation with one of a matched filter detection and iterative linear minimum mean-squared error MMSE detection.

7. The method of claim 5, wherein obtaining respective log-likelihood ratios LLRs for a particular subcarrier comprises determining a covariance matrix of residual interference plus noise according to the relationship Σₖ=Hₖ^{T}VₖHₖ+σ²I, where Hₖ^{T} is a channel matrix over T transfers of the matrix, Vₖ is a residual interference, σ² is a variance of the noise and I is an identity matrix.

8. The method of claim 7, further comprising determining an inverse of the covariance matrix of residual interference plus noise denoted as Σₖ⁻¹.

9. The method of claim 5, wherein obtaining respective log-likelihood ratios LLRs for a particular subcarrier comprises determining a noise whitening matrix which is the product of an inverse of a covariance matrix of residual interference and a channel matrix.

10. The method of claim 1, wherein obtaining respective log-likelihood ratios LLRs for a particular subcarrier comprises for every input binary bits n=1, . . . , 2n_{T}L, where n_{T} is the transmitter antenna and L is the number of layers, is responsive to a linear MMSE filter matrix Wₖ and a unit vector eₙ.

11. The method of claim 5, wherein obtaining respective log-likelihood ratios LLRs for a particular subcarrier comprises for every input binary bits n=1, . . . , 2n_{T}L, where n_{T} is the transmitter antenna and L is the number of layers, with a linear MMSE filter denoted as ω_{k,n}=Wₖeₙ, with Wₖ being the linear MMSE filter matrix and eₙ being a unit vector, first obtaining an intermediate computation denoted as {Ω^{k}]ₙₙ=ω_{k,n}^{T}Hₖeₙ, then determining the extrinsic LLR output from the MMSE multilayer MIMO detector given by
$${λ}^{M \to D} ( {\tilde{s}}_{k , n} ) = \frac{2}{{κ}_{k , n} - {[ {Ω}_{k} ]}_{nn}} ( {ω}_{k , n}^{T} ( {\tilde{y}}_{k} - {ℋ}_{k} {\overline{s}}_{k} ) + {[ {Ω}_{k} ]}_{nn} {\overline{s}}_{k , n} ) ,$$
where K_{k,n} is 1+ s̅_{k,n}²[Ωₖ]ₙₙ, with s̅_{k,n}² being the square of the soft signal estimate multiplied by the intermediate computation [Ωₖ]ₙₙ.

12. In a wireless wideband MIMO-OFDM transmission system, an apparatus comprising:
converters for converting respective coded bit sequences to parallel data layers, responsive to channel encoding and interleaving of an information sequence to provide the coded bit sequence;
repetition encoders responsive to the respective data layers,
independent interleavers responsive to respective spread data sequences from the respective repetition encoders, and
amplifiers for amplifying respective interleaved outputs responsive to power allocation of respective layers of multiple layers for both I and Q channels for being combined to form complex symbols for transmission through respective multiple antennas.

13. The apparatus of claim 12, wherein the amplifiers comprise amplitude factors Aₗ, where Aₗ=√Pₗ, and Pₗ denotes the power allocation of the lth layer for both the I and Q channels.

14. The apparatus of claim 13, wherein the power allocation is directly proportional to Pe^{α(l-1)/N}, where P is the total power in the system, N is a length of spreading repetitions of the spreading encoder, e is the exponential constant, l is an lₜₕ layer of the total number of data layers and α is a single parameter for adjust the power levels across different layers to change performance the wideband MIMO-OFDM transmission system.

15. The method of claim 13, wherein the power allocation is indirectly proportional to e^{α(l-1)/N}, where N is a length of spreading repetitions of the spreading encoder, e is the exponential constant, l is an lₜₕ layer of the total number of data layers and α is a single parameter for adjust the power levels across different layers to change performance the wideband MIMO-OFDM transmission system.

16. The method of claim 12, further comprising a detector for detecting information from reception of the transmitted complex symbols for obtaining respective log-likelihood ratios LLRs for all the data layers.

17. The method of claim 16, wherein obtaining respective log-likelihood ratios LLRs for a particular subcarrier comprises determining a covariance matrix of residual interference plus noise according to the relationship Σₖ=Hₖ^{T}VₖHₖ+σ²I, where Hₖ^{T} is a channel matrix over T transfers of the matrix, Vₖ is a residual interference, σ² is a variance of the noise and I is an identity matrix.

18. The method of claim 16, wherein obtaining respective log-likelihood ratios LLRs for a particular subcarrier comprises determining a noise whitening matrix which is the product of an inverse of a covariance matrix of residual interference and a channel matrix.

19. The method of claim 16, wherein obtaining respective log-likelihood ratios LLRs for a particular subcarrier comprises for every input binary bits n=1, . . . , 2n_{T}L, where n_{T} is the transmitter antenna and L is the number of layers, is responsive to a linear MMSE filter matrix Wₖ and a unit vector eₙ.

20. The method of claim 16, wherein obtaining respective log-likelihood ratios LLRs for a particular subcarrier comprises for every input binary bits n=1, . . . , 2n_{T}L, where n_{T} is the transmitter antenna and L is the number of layers, with a linear MMSE filter denoted as ω_{k,n}=Wₖeₙ, with Wₖ being the linear MMSE filter matrix and eₙ being a unit vector, first obtaining an intermediate computation denoted as [Ωₖ]ₙₙ=ω_{k,n}^{T}Hₖeₙ, then determining the extrinsic LLR output from the MMSE multilayer MIMO detector given by
$${λ}^{M \to D} ( {\tilde{s}}_{k , n} ) = \frac{2}{{κ}_{k , n} - {[ {Ω}_{k} ]}_{nn}} ( {ω}_{k , n}^{T} ( {\tilde{y}}_{k} - {ℋ}_{k} {\overline{s}}_{k} ) + {[ {Ω}_{k} ]}_{nn} {\overline{s}}_{k , n} ) ,$$
where k_{k,n} is 1+ s̅_{k,n}²[Ωₖ]ₙₙ, with s̅_{k,n}² being the square of the soft signal estimate multiplied by the intermediate computation [Ωₖ]ₙₙ.

21. The method of claim 5, further comprising the steps of
passing multiple streams of extrinsic LLRs from soft combiners by an extrinsic scaling for being multiplied by a given scaling factor less than 1,
interleaving the scaled multiple extrinsic LLRs, and
providing the interleaved scaled multiple extrinsic LLRs as priori inputs for the step of detecting.
